(19) United States
(12) Patent Application Publication
(10) Pub. No.: US 2010/0304983 A1
(43) Pub. Date: Dec. 2, 2010

(54) METHOD FOR PROTEIN STRUCTURE DETERMINATION, GENE IDENTIFICATION, MUTATIONAL ANALYSIS, AND PROTEIN DESIGN

(75) Inventors: Charles Michael Fortmann, Bellport, NY (US); Yeona Kang, Coram, NY (US); David H. Coleman, Vancouver (CA)

Correspondence Address: BAKER BOTTS L.L.P., 30 ROCKEFELLER PLAZA, 44TH FLOOR, NEW YORK, NY, 10112-4498, US

(73) Assignee: The Research Foundation of State University of New York, Stony Brook, NY (US)

(21) Appl. No.: 12/301,963

(22) PCT Filed: Apr. 18, 2008
(86) PCT No.: PCT/US2008/060786

§ 371 Date: Aug. 5, 2010

(30) Foreign Application Priority Data
Apr. 27, 2007 (US) PCT/US2007/067639

(51) Int. Cl. C40B 30/02

(52) U.S. Cl. 506/8

(57) ABSTRACT

An efficient computational method and system for predicting the folding regions and associated secondary and tertiary structures of a protein is disclosed. Methods and systems for sorting amino acid sequences based on predicted structures, as well as methods and systems for determining the presence or absence of genes in nucleic acid sequences or structural mutations in amino acid sequences are also disclosed. A method and system for the design of a protein is also disclosed.

### CROSS-REFERENCE TO RELATED APPLICATIONS

The present application is a continuation-in-part of International Patent Application PCT/US07/067,639 filed Apr. 27, 2007, entitled “A Method For Determining And Predicting Protein Autonomous Folding,” and claims priority from U.S. Provisional Application No. 60/808,167 filed May 23, 2006, entitled “Protein Autonomous Folding Units, Folding Dynamics and Structure,” the entirety of both of which are hereby incorporated by reference.

### BACKGROUND

The present invention relates to computational methods for protein structure determination and prediction, and utilization of the protein structure determination methods for gene identification, mutation analysis, and protein design.

### Methods for Protein Structure Determination

The secondary and higher-order structures of a protein dictate its function and biological activity, and are therefore critical to many fundamental life processes. Experimentally, such structures are often obtained through crystallography based on the assumption that the most stable conformation of a protein in solution is approximately the same as its crystallized form. However, crystallography is currently unfeasible for a majority of proteins, and the experimental conditions for crystallography may deviate far from the natural environment (e.g., physiological condition) for the proteins so as to give a false indication of structure. An alternative experimental technique for protein structure determination, Nuclear Magnetic Resonance Spectroscopy (NMR), is usually limited to small-sized proteins because of its low inherent sensitivity and the high complexity and information content of NMR spectra.

With the dramatic increase of the computing speed of modern day computers in recent decades, computational methods for protein structure prediction have taken an increasingly important role in structural biology. Current approaches to computational analysis are usually based on comparisons to previously described sequences and structures. For example, homology modeling is often used to predict the three-dimensional structure of a protein or polypeptide sequence based on sequence or structural alignment of the protein or polypeptide with a “template” protein that has a known structure (the term “known” in the present application refers to the public accessibility of the sequence identity of a DNA sequence, and in the case of an amino acid sequence, the public accessibility of the sequence identity and three-dimensional structure determined by experimentally by crystallography or NMR). Examples of a sequence-based homology approach include using such alignment tools at BLAST or FASTA to directly assess similarity between primary amino acid sequences, and to predict the structure of a sequence based on its sequence similarity to a sequence with a known structure. Examples of a structure-based homology approach include threading algorithms, which predict structure by superimposing an amino acid sequence onto a known structure and then assessing whether that conformation of amino acids would still retain the same equilibrium of hydrophobic/hydrophilic forces that allow for the structure to be stable. However, for both approaches, only a very limited number of proteins can provide such “templates” for comparative analysis. Therefore, for a protein of interest, a suitable template for homology analysis may be difficult to find, especially in the case of a novel artificial protein. Furthermore, even if such template is found, homology modeling is unable to predict the structure of those portions of the sequence that are unmatched by the template in addition to the fact that each amino acid sequence may have different degrees of divergence from the template sequence.

Alternatively, physics-based computational methods have been employed for protein structure determination, of which energy minimization is a typical example. Due to the enormous conformational space of a large size protein, energy minimization usually does not yield a folded structure with a global free energy minimum because of its lack of modes of motion to facilitate crossing of barriers of local energy minima. Molecular dynamics is another example of a physics-based method. It explicitly employs Newtonian motion functions to track a temporal evolution of a molecular system. Because of this explicit exploitation of the laws of physics in the temporal dimension, the molecular dynamics method is extremely computationally expensive due to the small time steps needed for the evolution to be physically meaningful, and the complex mathematical integration schemes needed to compute the motion functions. Molecular dynamics has had limited success with small-size biomolecules or isolated local fragments in larger biomolecules, but the approach has been of little use for global phenomena of a large biomolecule over a much larger time frame (e.g., the autonomous folding of a protein into its native state in aqueous solution, a process that may take in the order of microseconds.)

Due to the importance of protein structure prediction and the enormity of challenges in solving it, protein structure prediction was listed as one of the 125 great unsolved problems in science (Science, 2005; 309: 78-102; Dill et al., Curr. Op. Struct. Biology; 2007, 17: 342-346).

Accordingly, there exists a need for an efficient physics-based computational method that incorporates external forces linked with a temporal dimension for predicting the secondary and higher-order structure of a protein or polypeptide sequence. Such external forces may provide the modes of motion to facilitate fast folding of a protein or polypeptide, and could also account for various environmental factors that influence the folded structure of the protein or polypeptide, such as temperature, pH, etc.

There also exists a need for an efficient computational method to predict the secondary and high-order structure of a protein or polypeptide without explicitly conducting a simulation of a physics-based model. Such a computational method may utilize knowledge gained by a simulation of a physics-based model, and may also utilize knowledge derived by homology modeling.

### Gene Analysis, Mutagenesis, and Protein Design

A given DNA sequence potentially encodes for many possible amino acid sequences, not all of which are transcribed and translated into a protein under natural conditions. Recent attempts to identify genes and establish their associated proteins have relied upon evolutionary, statistical, and/or experimental input. These evolutionary and/or statistical based models fail to produce a link between a nucleic acid sequence and an amino acid sequence with high degree or precision due to their inherent inadequacies, such as their inability to account for the potentially large impact of seemingly small variations in amino acid sequence on the secondary structure of a protein, and their inability to determine amino acid secondary structure in different environments such as different temperatures, pH levels, etc.

The advent of DNA sequencing technology has allowed for the large-scale analysis of genes and proteins. However, the high-throughput methods for DNA sequence annotation rely on homology to coding regions or folding patterns of the proteins translated that are experimentally obtained, and have severe limitations in their capability to identify new coding regions and new folds. Physical methods for transcription analysis, such as the study of cDNA libraries have also fallen short due to inherent biases in the transcription pool and in the construction and study of the library itself. Therefore, there is a need for a method to better link a genotype with its corresponding phenotype utilizing a computational method that is able to predict secondary or higher structures of a protein. Also, there is a need for a method that allows the identification of potential protein coding regions in a given DNA sequence.

Variations of the sequence of a natural protein may be characterized as neutral mutations (mutations that do not lead to altered structure or function of the protein), structural mutations (mutations that lead to altered structure of the protein, but not necessarily altered function), or functional mutations (mutations that lead to loss or gain of function of the protein). Such variations may result in differences within a population and/or result in diseases, and therefore would provide useful information for evolutionary analysis, and medical analysis of the root cause of the disease. Further, it would allow more accurate evolutionary analysis by identifying homologous and analogous mutations to both structure and function. Understanding which mutations are neutral, structural, or functional will allow for more accurate diagnostics and aid in the design of more effective treatments. Therefore, there exists a need for a method to predict the impact of variations in an amino acid sequence of a protein on the secondary or higher-order structure of the protein.

With the advent of DNA technology, it is now also possible to produce synthetic proteins, synthetic genes, synthetic genomes and synthetic organisms. Therefore, there exists a need for a method to design a family of amino acid sequences and to select from such a family of amino acid sequences those sequences that fold into a desired secondary or higher-ordered structure for use as a protein or part of a protein.

### SUMMARY

The present invention provides a computational method that upon being given an input of an amino acid sequence of a protein or polypeptide, determines and/or predicts the presence or absence of secondary and/or tertiary structure(s) of a protein or polypeptide, as well as the size and position of the secondary and/or tertiary structure(s). Protein structures, such as secondary and tertiary structures, include but are not limited to the types of structures described in established protein classification systems such as CATH and SCOP. For example, the secondary structures may be alpha helices or beta sheets. The method is hereinafter referred to as “the Fortmann-Kang-Coleman method,” or “the FKC method.”

The FKC method is based on a molecular model described by physical parameters such as amino acid sequence and the net charge and hydrophobicity of each amino acid residue on the amino acid sequence, as well as environmental variables such as ionic strength, pH, temperature, pressure, etc. The determination or prediction of folded regions of a protein or polypeptide is based on examining the given amino acid sequence, the physical parameters defining each amino acid residue and the environment of the amino acid sequence, without the need to carry out computer simulations or output graphics representing the folded structure. Therefore, the FKC method is highly computationally efficient and may be used for high-throughput analysis of genomes and proteins.

In some embodiments, the FKC method extends and streamlines the computational method described in the International Patent Application PCT/US07/067,639 by Fortmann and Kang, filed Apr. 27, 2007, the disclosure of which is fully incorporated herein in its entirety. In that application, a computational method (referred to hereinafter as “the Fortmann-Kang method”, or “the FK method”) was described which enables expedited determination and/or prediction of secondary and higher ordered structures (including, but not limited to, alpha helices and beta sheets) of a protein, a polypeptide, or an autonomous folding region thereof. Although computer simulation is necessary in the FK method to determine a protein structure, because of the high computational efficiency of the FK method, it is useful for high-throughput analysis of genomes and proteins. In the meantime, an explicit simulation using the FK method may provide a wealth of information about molecular forces and folded structures, which can in turn be fed into FKC method for the modification of its input parameters, and/or for the self-tuning of the FKC method.

In one embodiment, the present invention provides a method for selecting an amino acid sequence upon given a nucleic acid. The method generates a probabilistic array of amino acid sequences that are potentially encoded by the nucleic acid, determines the folded region of each of the amino acid sequences generated using the FKC method, and selects the amino acid sequence having the most secondary structures.

In one embodiment, the present invention provides a method for sorting an array of amino acid sequences potentially encoded by a given nucleic acid. The method determines the folded region of each of the amino acid sequences, and sorts the amino acid sequences according to the type, order and/or number of the predicted folded regions that each amino acid sequence produces.

In another embodiment, the present invention provides a method for determining the presence or absence of a gene in a nucleic acid sequence.

In another embodiment, the present invention provides a method for determining the presence or absence of a structural mutation in an amino acid sequence.

In yet another embodiment, the present invention provides a method for the design of a protein.

### BRIEF DESCRIPTION OF THE FIGURES

FIG. 1 is a functional diagram of an exemplary system and process in accordance with the present invention.

FIG. 2 is a process diagram of an exemplary process in accordance with the present invention.

FIG. 3 is a process diagram of an exemplary process in accordance with the present invention.

FIG. 4 is a process diagram of an exemplary process in accordance with the present invention.

FIG. 5 is a process diagram of an exemplary process in accordance with the present invention.

FIG. 6 is a process diagram of an exemplary process in accordance with the present invention.

FIG. 7 is a process diagram of an exemplary process in accordance with the present invention.

FIG. 8 is an illustrative graph depicting the predicted structure of an amino acid sequence.

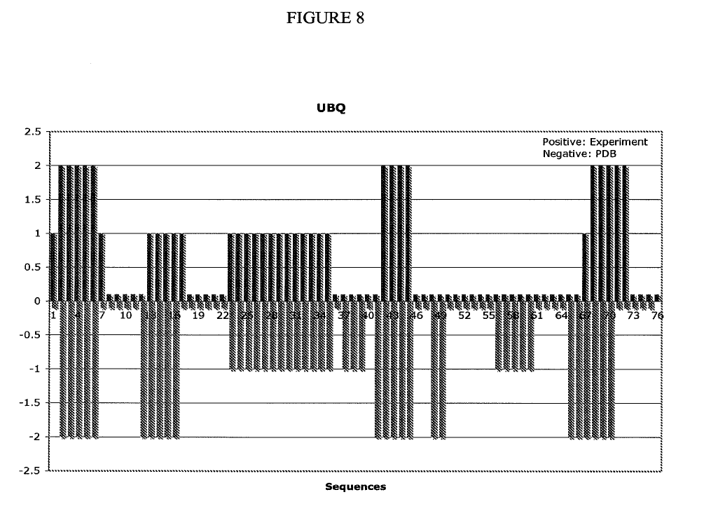

FIG. 9 is an illustrative graph depicting the predicted structure of an amino acid sequence.

FIG. 10 is an illustrative graph depicting the predicted structure of an amino acid sequence.

### DETAILED DESCRIPTION

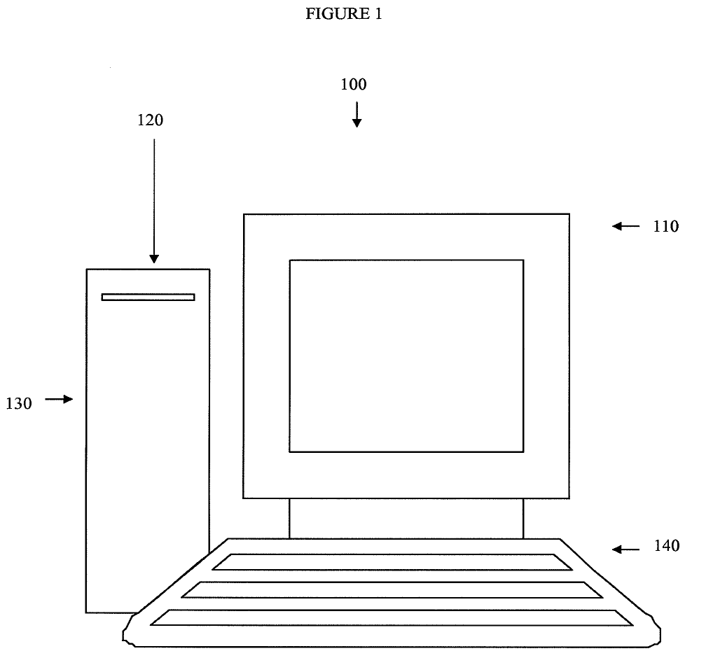

Referring to FIG. 1, a preferred arrangement of the present invention will be described with respect to a process that may be performed manually or automatically on a system 100, including a computer 110, with a memory 120, processor 130, and data entry device 140. In an exemplary embodiment, system 100 includes a IBM-PC compatible computer platform and a memory 120. Computer 110 is a PC, but may be any form of conventional computer. Memory 120 is a hard drive, but may be any form of accessible data storage, while Processor 130 may be any type of conventional processor. Data entry device 140 is a keyboard, but may also include other data entry devices such as a mouse, an optical character reader, or an Internet connection for receiving electronic media. Although the invention will now be described with reference to this exemplary embodiment, those of ordinary skill in the art will appreciate that the invention may be practiced by other than the described embodiment.

In one aspect, the present invention provides a computational method that, upon being given an input of an amino acid sequence of a protein or polypeptide, determines and/or predict the presence or absence of a folded region, such as secondary and/or tertiary structure(s), of the protein or polypeptide, as well as the size and position of the predicted secondary and/or tertiary structure(s). The method is referred hereinafter as the FKC method.

The FKC method is related to the computational method described in the International Patent Application PCT/US07/067,639 by For Unarm and Kang, filed Apr. 27, 2007, the disclosure of which is fully incorporated herein in its entirety. In that application, Fortmann and Kang described a computational method (“FK method”) which enables expedited determination and/or prediction of secondary and higher ordered structures (including but not limited to alpha helices and beta sheets) of a protein, a polypeptide, or an autonomous folding region thereof. As used herein, the term “folding region” (or “folded region,” “folded structure”) refers to a fragment or section of a protein or polypeptide sequence, wherein at least a portion the amino acid residues within such fragment or section form at least one secondary or tertiary structure. The term “secondary structure” refers to a pattern of spatial arrangement by the local segments of a given protein or amino acid sequence, whereas the term “tertiary structure” refers to a longer-ranged structural pattern formed by the secondary structure(s) or individual amino acid residues on the sequence.

Similar to the original FK method, the FKC method is based on a molecular model described by physical parameters such as the amino acid sequence and the net charge and hydrophobicity of each amino acid residue on the amino acid sequence. However, the FKC method can predict the secondary or higher structure of a protein by simply examining the sequence of the input amino acid and the physical parameters, without the need to conduct a computer simulation of the protein folding. The FKC method can denote each amino acid residue on the given amino acid sequence as belonging to a secondary or tertiary structure and present the output in a tabular or graphic form instead of a three dimensional representation of the folded structure.

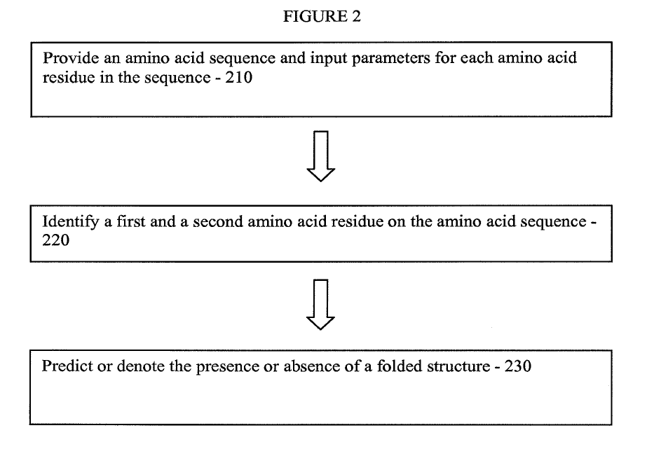

The FKC method is illustrated in FIG. 2. At 210, an amino acid sequence is provided, along with input parameters for each of the amino acid residues in the sequence. The input parameters include charge, hydrophobicity value, size, polarity, and other properties that describe an amino acid residue. At 220, a first and a second amino acid residue on the amino acid sequence are identified. The first and the second amino acid residues may be identified based on the input parameters and are generally two closely spaced (e.g., separated by 5 or fewer residues on the contour of the amino acid sequence) non-polar (or hydrophobic, by definition with zero charge) amino acid residues. These two closely spaced non-polar residues are also termed the “boundary residues” in the present application. At 230, the presence or absence of a folded structure between (and including) the two identified amino acid residues is predicted and/or denoted.

The previously-disclosed FK method describes that closely spaced, non-polar amino acid residues attract one another whenever the net charges existent on intervening residues in such regions between the two non-polar amino acid residues conform to a relation of charge neutrality (or near charge neutrality). For example, the following equation usefully defines the possibility for blocking non-polar residue interaction:

$$\vert {\sum }_{i} {q}_{i} \vert = {\sum }_{i} \vert {q}_{i} \vert \qquad ( 1 a )$$

where qᵢ is the nominal (or net) charge of each amino acid residue between the two identified boundary residues, and i denotes the number of such intervening amino acid residues. This blocked non-polar interaction is essential for beta sheet formation. Whenever the conditional described by Equation 1a is met for all amino acid residues between the two identified boundary residues, the FKC method in the present invention will identify the region comprising these intervening amino acid residues as a beta sheet.

The charge values of an amino acid residue may be obtained from various software suites or from calculations based on first principles. For example, they can be obtained from the software MOLECULAR OPERATING ENVIRONMENT™ (“MOE”, by Chemical Computing Group, Montreal, Quebec, Canada), or, they can be obtained by using the tight-binding methods described by Walter A. Harrison, Electronic Structure and the Properties of Solids: The Physics of the Chemical Bond, W.H. Freeman, San Francisco, 1980.

Alternatively, when a protein or a proposed amino acid sequence does not correspond to a known folded shape, fractional electronic charge units may be used, Equation 1a may be modified as:

$${\sum }_{i} \vert {q}_{i} \vert - \vert {\sum }_{i} {q}_{i} \vert \leq α \qquad ( 1 b )$$

where α is a number sufficiently close to zero to describe a region in which charge-related electric fields are sufficiently large so as to energetically prohibit the displacement of water thereby forming a beta sheet region.

When the condition of Equation 1 is not met for all amino acid residues between the two identified boundary residues, that is, when:

$$\vert {\sum }_{i} {q}_{i} \vert \neq {\sum }_{i} \vert {q}_{i} \vert , \qquad ( 2 a )$$

the FKC method identifies the region between the boundary residues as an alpha helix. Equation 2a may be further modified for cases in which the partial or fractional electronic charge data is used:

$${\sum }_{i} \vert {q}_{i} \vert - \vert {\sum }_{i} {q}_{i} \vert > α \qquad ( 2 b )$$

Alternatively, an alpha helix may be predicted when there exists a predominance of charge neutrality by all but one of the amino acid residues in the region between the two boundary residues. This one amino acid residue may attain a position external to the shared vapor core region connecting the two boundary residues whereby the shared water/vapor and water/non-polar residue surface can be minimized by rotating out of the forming alpha helix core, thereby allowing the formation of the alpha helix structure to proceed. Therefore, an alternative condition for alpha helix formation is:

$$\vert {\sum }_{j} {q}_{j} \vert \leq α \qquad ( 2 c )$$

where α is a number sufficiently close to zero and j is one less than the number of the intervening residues between the two boundary residues under consideration. Accordingly, potentially different combinations of residues may contribute to the sum expressed in Equation 2c. If any of such combinations satisfy Equation 2c, then this region is predicted as an alpha helix.

For determining an alpha helix or beta sheet structure using the FKC method, the parameter α may be varied to reflect differences that may relate to specific examples of amino acid sequence and/or environmental considerations (e.g., those factors that alter the dielectric constant of the water and/or media in which the amino acid sequence is placed). The number a may be set systematically, scanned through, and/or through examination of a known homologous structure. Generally, a may be set as 0.01˜0.5, more preferably 0.05˜0.25. If there exists a homologous protein with experimentally determined structure, the structures generated by the simulation for various α values may be compared to the known structure of the homolog to best fit the homolog structure. Further, the distance between the two boundary hydrophobic residues may be chosen in the range of 3-11 residues (on the contour of the amino acid sequence), preferably 4-8 residues, with 5 as a useful default value.

The repeating of a pattern of non-polar residues being spaced sufficiently close and having intervening amino acids conforming to Equation 1a or 1b is identified by the FKC method as an extended beta sheet region. Likewise, a region having repeat patterns described by Equation 2a, 2b or 2c is identified as an extended alpha helix region.

When a non-polar residue and the next non-polar residue on the amino acid sequence is spaced by more than a predetermined number of residues on the contour of the amino acid sequence, the FKC method identifies such an intervening region as an unstructured region.

The FKC method can output a graphical representation, or a tabular list of amino acid residues in the sequence with each residue annotated with an indicator of structure each amino acid belongs to: an alpha helix, a beta sheet, or an unstructured region.

The parameters (for example, the value α in Equations 1-2) used in the FKC method may be varied according to the temperature and/or other environmental factors. Environmental effects include: local ion concentrations; environmentally induced chemical changes resulting in a new charge and/or new charge state on an atom and/or residue (e.g., but not limited to pH change, oxidation, ionizing radiation, and/or reduction); changes in the dielectric and/or charged species content, and/or surface energy of the media in which the protein under consideration is suspended; and, changes in temperature and/or thermal energy. In the case where the environment induces or neutralizes the nominal charge of residues and/or backbone atoms, the relevant charge summation tests (i.e., Equations 1-2) for helix and beta sheet formations are carried out with the new environmentally-altered charge distributions. In general, the value of α should be decreased with increasing temperature to reflect an increased propensity for the alpha helix to denature upon heating.

Environmental changes that influence the strength and/or distance of the hydrophobic interactions between amino acid residues include but are not limited to: the dielectric strength of the media, the surface tension of the dielectric media, vapor bubble (including cavitations) size and distribution, and temperature. Factors that decrease the interaction length (e.g., decreased media dielectric strength) may be modeled with a reduced value for the pre-determined distance, i.e., the chosen number of intervening residues for identifying the two boundary residues. Factors that increase interaction length, such as increased dielectric strength, increased vapor bubble size and/or density, and increased surface energy, may be modeled with an increase in the pre-determined distance. Increasing temperature decreases the interactions between two hydrophobic residues, and the extent of such decrease depends upon the media and the temperature dependence of its related properties (including the dielectric strength, vapor bubble size and distributions, as well as surface energy). Accordingly, the predetermined distance for identifying the two boundary residues can be reduced.

Selecting an appropriate parameter of α or i may be conveniently accomplished by using homology and/or an observation of a known protein structure as a function of the environmental parameter in question, for example, by sweeping through a range of i values between, e.g., 3 to 11 residues and/or the parameter α, e.g., between 0 to 0.25 in steps of 0.05.

The FKC method may utilize homology information to self-tune when the provided amino acid sequence has a sequence homologous to an amino acid sequence with experimentally determined secondary or tertiary structure(s). This feature can make use of natural tertiary interactions that modify parameters governing secondary structure generation. For example, homology may permit a more refined choice of parameter α and the number of intervening residues between the two boundary hydrophobic residues.

The FKC method may further be configured to predict and denote tertiary structure of a protein or polypeptide. This can be done by incorporating forces arising between the secondary structures, such as hydrogen bonding and Van Der Waals forces. A modified version of the original program may be run after establishing the presence of secondary structure in which closely-spaced secondary structures are allowed to interact in accordance with a predetermined interaction template. For example, the FKC method may be first used to identify secondary structures in an amino acid sequence. The residues in these identified secondary structures are then combined into groups and treated as single resides. An appropriate value of charge and hydrophobicity is assigned to each of the groups. Using the parameters of the grouped structures, the FKC method is then utilized to determine the tertiary structure. Considerations for interaction may include, among other things, distance, net charge, charge distribution, and environmental charge. For example, alpha helices will more likely be found in regions with low electric field, and closely spaced beta sheets form stacks when net charge is opposite (attraction) and form beta barrels when net charges are similar (repulsion). Also, the modified program may allow a number (greater than three) of nearly spaced beta sheets (e.g., three residues distant) to form a beta barrel. Said modified program may be improved by comparison with known structures.

A given DNA sequence may be translated in six reading frames to produce all possible amino acid sequence that may be potentially encoded by the DNA sequence. The resulting amino acid sequences may be run through a protein folding algorithm, such as the FK method or the FKC method, to determine the presence of a folding region.

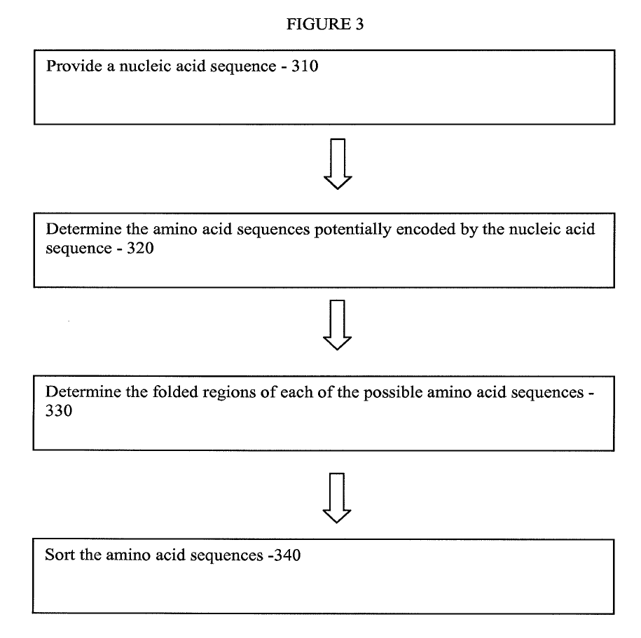

In one embodiment of the present invention, as illustrated in FIG. 3, the FKC method is used to sort amino acid sequences based on the combination of predicted secondary structures present within the sequence. At 310, a nucleic acid sequence is provided. At 320, the nucleic acid sequence is translated to an array of amino acid sequences that may be potentially encoded by the nucleic acid sequence. At 330, a protein structure prediction method, such as the FKC method or the FK method, may be used to determine the folded regions of each of the translated amino acid sequences. At 340, the predicted folded regions are sorted. For example, the predicted folded regions may be sorted by the type, order, and number of the secondary structures present to produce such general categories as all alpha helix, all beta sheet, or a mixture of alpha helix and beta sheet, or such specific categories for alpha helix (A) and beta sheet (B) as: A, B, AA, AB, BA, BB, AAA, etc. Once sorted into such categories, the results may then be annotated using such structural databases as CATH and SCOP in order to assign potential function and potential higher structures.

Homology-based information may be employed in the above method to improve its accuracy. For example, if the provided nucleic acid sequence has a sequence homologous to a nucleic acid sequence known to encode a particular amino acid sequence, then this information may be used to prioritize which nucleic acid sequences will be analyzed first or if at all. Or, if one of the generated amino acid sequences is homologous to an amino acid sequence with an experimentally determined 3-D structure accessible in a public database, then this information may be used to prioritize which predicted fold will be selected first or if at all for further investigation.

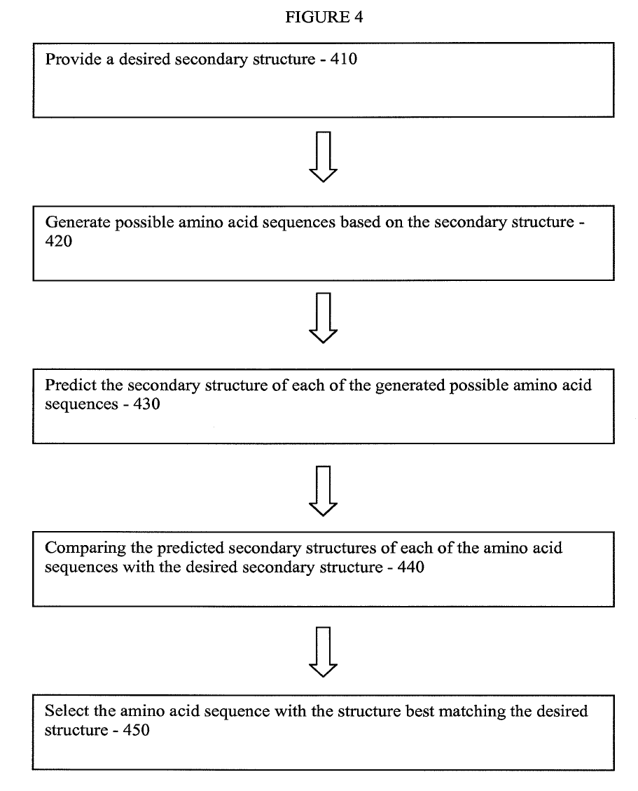

In another embodiment, as illustrated in FIG. 4, the amino acid sequence of a polypeptide with a desired pre-determined secondary structure is determined. At 410, a desired pre-determined secondary structure or function of a protein or polypeptide is provided. At 420, an initial amino acid sequence(s) is chosen either randomly or from a list of pre-determined amino acid sequences known to fold into a structure that is similar to the desired structure or from a list of pre-determined amino acid sequences known to encode for a protein that has a similar function to the desired protein. This sequence(s) is then randomly mutated to produce a new sequence(s). At 430, a protein structure prediction method, such as the FKC method or the FK method, is used to predict the secondary structures of the mutated new sequence(s). At 440, the predicted secondary structures of each of the amino acid sequences are compared with the desired secondary structure. At 450, the amino acid sequence having the predicted secondary structure that most closely fits with the pre-determined secondary structure provided is selected.

An amino acid sequence of a gene product will necessarily fold into certain secondary structures, e.g., alpha helices or beta sheets. Accordingly, the present invention may also be used to determine whether there exists a potential gene in a given nucleic acid sequence.

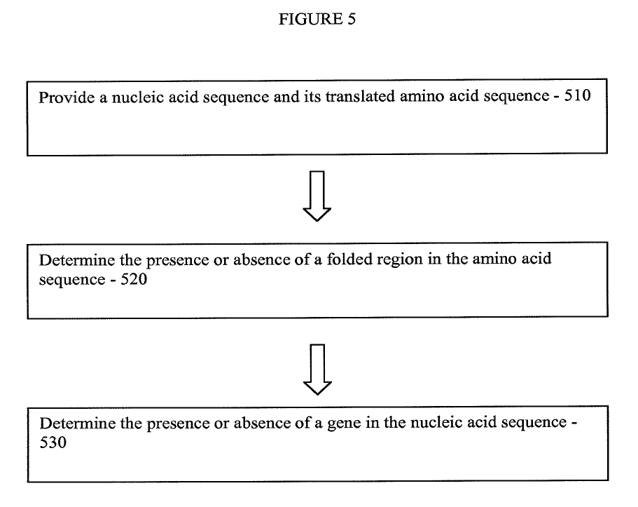

In one embodiment, as illustrated in FIG. 5, a method of determining the presence or absence of a gene in a nucleic acid sequence is provided. At 510, a nucleic acid sequence is given, and a corresponding amino acid is obtained through the translation of the nucleic acid. At 520, the presence or absence of a folded region in the amino acid sequence is determined using a protein structure prediction method, for example, the FKC method or the FK method. At 530, the presence or absence of a gene in the nucleic acid sequence is determined based on the presence or absence of a folded region in the amino acid sequence.

In the above embodiment, the predicted folded regions may be alpha helices or beta sheets, while the nucleic acid sequences may be DNA, RNA or cDNA. The pattern of the predicted amino acid sequence structures may be matched to known proteins or to known sequence motifs to further determine whether the gene identified may transcribe and translate into a protein, or will remain inactive.

Moreover, the method above may utilize information gained from sequence homology in order to define transcription boundaries. This may be accomplished by establishing homology to known transcribed regions, such as those present in a cDNA library, and to known transcriptional motifs such as start and stop codons, splice sites, promoters, regulatory elements and structure elements, to aid the determination of the existence of a gene in the nucleic acid. Homology to known transcribed regions and to known sequence motifs could be used at the start of the folding method to divide up the DNA sequence into smaller units, or at the end of the folding method to group the predicted secondary structures into units or segments representing single proteins or subunits of a single protein. Even if the region is not transcribed, the region may contain an inactive gene, sometimes referred to as a “fossilized” gene, which may be used to infer evolutionary information about the protein. The KFC method will enable the study of the predicted folded structures of such a gene as they are not normally transcribed.

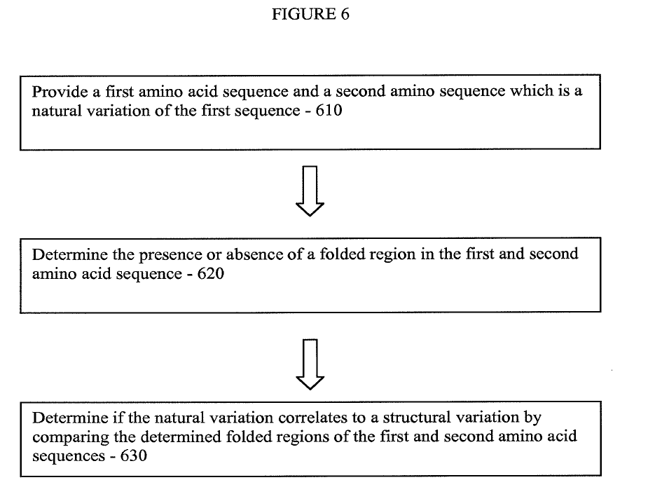

In one embodiment, as illustrated in FIG. 6, the correlation between a natural variation of an amino acid sequence and the structural mutation is determined. At 610, a first amino acid sequence and a second amino sequence is provided, wherein the second amino acid sequence comprises at least one mutated amino acid residue compared to the first amino acid sequence. The first amino acid sequence may be a naturally occurring protein. At 620, the folded region(s) of the second amino acid sequence is determined by a protein structure prediction method, such as the FKC method or the FK method; the folded region(s) of the first amino acid sequence may be obtained either from available experimentally data (by crystallography or NMR), or by using a protein structure prediction method, such as the FKC method of the FK method. At 630, the predicted folded region of the second amino acid sequence is compared to the folded region in the first amino acid sequence to determine the effect of natural variation of the first amino acid sequence on the folded structure of the amino acid sequence. The mutation may be a point mutation, a deletion mutation, an insertion mutation, an inversion mutation, and an alternate splice. The predicted folded region may be either an alpha helix or a beta sheet.

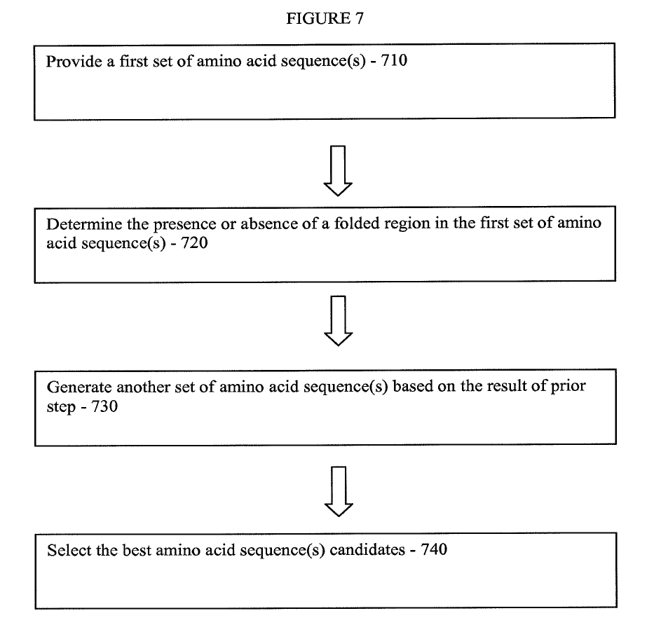

In another embodiment, a protein sequence is designed by generating and refining a set of one or more amino acid sequences, as illustrated in FIG. 7. At 710, a first set of one or more amino acid sequences is provided. The amino acid sequence(s) may be either naturally occurring or artificial. At 720, this first set of amino acid sequence(s) is tested for the presence or absence of a folding region(s) using a method of protein structure prediction, such as the FK method or the FKC method. The absence or presence of the folding region(s) may then be used to determine if the amino acid sequence will have a structure that will produce the desired function.

The first set of one or more sequences of amino acid sequences may be refined by selected mutation of their sequences. The mutation may be random mutation or directed mutation. The type of mutation may be a point mutation, a deletion mutation, an insertion mutation, an inversion mutation, and an alternate splice. The considerations for selection of the mutation may be based on the preservation of structure where one wishes to modify a protein's characteristics without altering the overall “lock and key” functionality provided by the protein's overall conformation. For instance, the stability of the protein may be altered by introducing a di-sulfide bond which would allow the protein to retain its conformation at a high temperature. Also, the strength of a protein's binding site may be altered by changing the side chains present at the binding location, thereby allowing the protein to bind more or less strongly to its target without altering the type of target that the protein binds. For both changes, the method of protein structure prediction could be used to confirm that these alterations to the characteristics of the protein will not interfere with the overall structure of the protein and so as to allow it to retain the function of its conformation.

Alternatively, the researcher may wish to mutate the amino acid sequence such that the amino acid sequence either no longer functions or acquires new functions based on its interaction with other proteins. This may be desired for disabling the function of the protein, for instance, when the researcher wishes to disable a critical protein in the lifecycle of a pathogen, or to disable a growth factor responsible for a cancer. It may also be desired to look for new functions of the protein, for instance, the researcher may wish to retain the binding site, but to alter the conformation so that the protein interacts with new targets and proteins of either natural or artificial origins.

If more than one amino acid sequences are used in the first set of amino acid sequence(s), the amino acid sequences may be sorted by type, number and/or order of folded regions predicted, and a new set of amino acid sequences may then be generated from the first set by mutation of highly ranked candidates. This new set of amino acid sequences may then be further mutated to generate yet another new set for testing. This process may be repeated to obtain better candidates. Finally, the best candidate amino acid sequences may be selected according to the criteria of type, number, and/or order of secondary structures required by the researcher (740). The above process may be performed according to a genetic algorithm.

The best candidate amino acid sequences obtained from the above embodiment may be translated back to a nucleic acid sequence for use as a gene. A collection of genes may be assembled into a synthetic genome. The synthetic genome may be used as the basis for a synthetic organism. At any point in the process, amino acid sequences may be further tested and refined.

### EXAMPLES

The following Examples merely illustrate some aspects of some embodiments of the present invention. The scope of the invention is in no way limited by the embodiments exemplified herein.

### 1. Computer Algorithm of the FKC Method

In one embodiment of the present invention, the FKC method is implemented as follows. qᵢ denotes the charge of the i-th residue in the given amino acid sequence, and χᵢ denotes the hydrophobicity value of the i-th residue (a positive χᵢ indicates that the residue is hydrophobic, and a negative χᵢ value denotes a hydrophilic residue). Both the charge and hydrophobicity value of an amino acid residue may be obtained by using the previously-mentioned MOE software or by data in Copeland (Robert A. Copeland, Methods for Protein Analysis: a Practical Guide to Laboratory Protocols, Chapman & Hall, NY 1994 p. 14), and/or by well-known experimental techniques or calculations. The pre-determined distance between the two boundary residues are arbitrarily chosen as 5 residues in some of the examples.

I. Simple helix determination:
1. Find a hydrophobic residue on the given amino acid sequence, denote its index as i−1.
2. Test the hydrophobicity of the next residue, i.e., check whether χᵢ>0
   (1) If the answer to the above inequality relation is no, go to the next residue,
   (2) Repeat (1) until the condition holds true.
      (a) Let j denote the index of the next hydrophobic residue found (j is less than i+5),
      (b) Check whether

$$\vert {\sum }_{k = i}^{j - 1} {q}_{k} \vert \leq α$$

where the residue with the largest charge is excluded in computing the summation. If this inequality is satisfied, then the region between the (i−1)th residue to the j-th residue is an alpha helix (labeled as “1”).
(c) If

$$\vert {\sum }_{k = i}^{j - 1} {q}_{k} \vert > α$$

when the residue with the largest charge is excluded in computing the summation, then the region between the (i−1)th residue to j-th residue is a β-sheet (labeled as “2”).

### II. Beta—Sheet Determination

Scan through the given amino acid sequence until a hydrophobic residue is encountered (let this be the (i−1)th residue), then check the hydrophobicity of the next j residues (j is less than or equal to i+4) in the sequence.
(1) If all residues with indices between i and i+4 satisfy Equation 1a or 1b, the region between the (i−1)th residue to the j-th residue is determined as a beta-sheet (labeled as “2”).
(2) If (i−1)th residue has a strong hydrophobicity (|χᵢ₋₁|>3) and i-th residue has a weak hydrophobicity (|χᵢ|<1) and charges of both (i−1)th and i-th residues are positive, then (i−1)th residue and i-th residue belongs to a beta-sheet (labeled as “2”).

### III. Advanced Alpha-Helix Determination

(1) If χᵢ₋₁>0 and χᵢ<0, start counting the number of residues until the next hydrophobic residue. There are five cases as follows:
   (A) Case I: χᵢ₊₁>0: The three residues ((i−1)-th to i-th) make an alpha helix (“1”)
   (B) Case II: Two hydrophilic residues are in between a hydrophobic residue and the next hydrophobic residue: if the sum of charges of the two hydrophilic residues is close to 0 (i.e., the absolute value of the sum of charges is smaller than a pre-determined small value α), the residues from residue (i−1) to residue (i+2) make an alpha helix (“1”).
   (C) Case III: Three hydrophilic residues are in between the hydrophobic (i−1)th residue and the next hydrophobic residue:
      (a) If

$$\vert {\sum }_{k = i}^{i + 2} {q}_{k} \vert \leq α ,$$

residues from (i−1) to (i+3) make an alpha helix (“1”).
(b) If the sum of charges of any two residues out of the three residues is sufficiently close to 0 (i.e., the absolute value of the sum of charges is smaller than a pre-determined small value α), then residues from (i−1) to (i+3) are determined to belong to an alpha helix (“1”).
(D) Case IV: 4 hydrophilic residues are in between the hydrophobic residue and the next hydrophobic residue on the sequence:
   (b) If

$$\vert {\sum }_{k = i}^{i + 3} {q}_{k} \vert \leq α ,$$

residues from (i−1) to (i+4) make an alpha helix (“1”).
(c) If the sum of the charges of any one combination of three residues out of the four residues (i.e., i-th residue to (i+3)-th residue) is sufficiently close to 0 (i.e., the absolute value of the sum of charges is smaller than a pre-determined small value β), then the residues from (i−1) the residue to the (i+4)th residue make an alpha helix (“1”).
(E) Case V: 5 hydrophilic residues in between a hydrophobic residue and the next hydrophobic residue:
   (a) If

$$\vert {\sum }_{k = i}^{i + 4} {q}_{k} \vert \leq α ,$$

residues from (i−1) to (i+5) make an alpha helix (“1”).
(b) If the sum of the charges of any one combination of four residues of the five residues is sufficiently close to 0 (i.e., the absolute value of the sum of charges is smaller than a pre-determined small value α), then the residues from the (i−1)th residue and the (i+4)th residue make an alpha helix (“1”).

### 2. The FKC Method Applied to Certain Amino Acid Sequences

Ubiquitin. Ubiquitin is a well-known protein having an experimentally determined structure. An embodiment of the FKC method was applied to Ubiquitin, while the possibility of a beta sheet beyond i=4 was disregarded (i is the number of intervening amino acid residues separated by two identified boundary residues). The result showed that the secondary structures and unstructured regions of Ubiquitin predicted by the FKC method match the experimental structure (obtained from Protein Data Bank (PDB) with PDB# UBQ) with an accuracy of 68.4%. Increasing the value of i, for example, to 5, 6, or 7, did not further improve the accuracy. Similarly, including amino acid molecular weights, and/or amino acid molecular size, and/or polar moment considerations did not produce improvement.

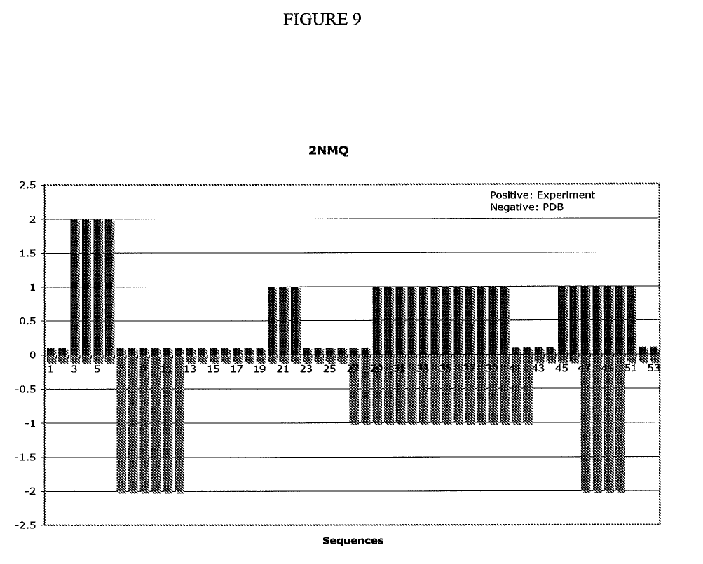

The result obtained by applying one embodiment of the FKC method on Ubiquitin compared with the experimentally obtained structure of Ubiquitin is illustrated in FIG. 9. The horizontal axis represents the amino acid residue index number on the Ubiquitin sequence, and the vertical axis represents the denotation of each amino acid residue on the Ubiquitin sequence as either belonging to an α helix (an assigned value of 1), a β sheet (value of 2) or an unstructured region (value of 0.1). The predicted structure is shown on the top of the horizontal axis and the experimentally determined is shown on the bottom of the horizontal axis. The value of 68.4% matching is obtained by dividing the number of matched residues by the total number of residues in Ubiquitin.

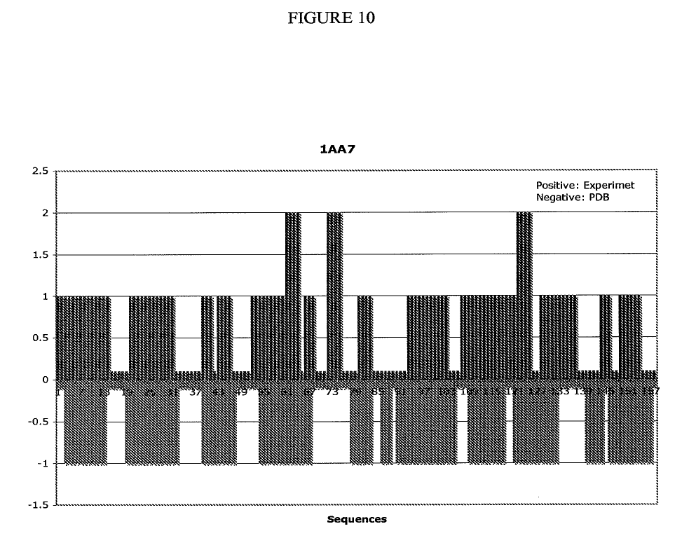

Group G Streptococcus. Group G Streptococcus is an important human pathogen and has an experimentally determined structure. One embodiment of the FKC method is applied to Group G Streptococcus where the pre-determined distance between the boundary residues is allowed to extend to a value of i=7, as illustrated in FIG. 10. The predicted structure of Group G Streptococcus is shown above the horizontal axis, as compared to the experimentally obtained structure (obtained from PDB by PDB# 2NMQ) shown below the horizontal axis. The value of 57% matching is obtained by dividing the number of matched residues by the total number of residues in Group G Streptococcus. If the matching criterion is relaxed so that the mismatching of the starting and stopping residues of the secondary structures is ignored, the percentage matching between the predicted structure and the PDB structure would be higher. Here again the inclusion of extra information such as molecular weights, size of the amino acid residues, and polar moment considerations did not produce improvement.

Influenza A virus. In this example, one embodiment of the FKC method is applied to Influenza A virus, and the result is illustrated in FIG. 11. The PDB structure of Influenza A (PDB#: 1AA7) virus has 11 α-helices. The predicted structure of this virus using the FKC method shows an overall 67.3% matching and 73% matching of the α-helices.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A method of predicting the presence or absence of a folded structure in an amino acid sequence, the method comprising:
providing:
an amino acid sequence,
a pre-determined value of hydrophobicity of each amino acid residue on the sequence,
and the charge of each amino acid residue on the sequence;
identifying a first and a second amino acid residue on the amino acid sequence that are separated by a pre-determined number of intervening amino acid residues on the contour of the amino acid sequence;
using the hydrophobicity of the first and the second amino acid residue and the sum of charges of the intervening amino acid residues to predict and/or denote the presence or absence of a folded structure.

2. The method of claim 1 wherein a folded structure is predicted to be present.

3. The method of claim 2, further comprising determination of the predicted folded structure.

4. The method of claim 3 wherein the predicted folded structure is a secondary structure selected from the group consisting of an alpha helix and a beta sheet.

5. The method of claim 1 wherein the amino acid sequence is derived from a DNA, RNA or cDNA.

6. The method of claim 1 wherein the predetermined distance between the first and the second amino acid residue is about 5 residues on the contour of the amino acid sequence.

7. The method of claim 1, wherein the method further incorporates an input parameter describing the environment of the amino acid sequence, the parameter is selected from the group comprising intercellular fluid dielectric character, temperature, electric field, and pH.

8. The method of claim 1, wherein the charge and/or hydrophobicity is varied according to a given environmental factor.

9. The method of claim 8, wherein the environmental factor is the temperature.

10. The method of claim 3, further comprising comparing the predicted structure against the known structure of a second homologous amino acid sequence, and using the information obtained to increase the accuracy of the determination.

11. The method of claim 1, wherein the method further comprises using forces comprising hydrogen bonding and van der Waals forces between the secondary structures, and wherein the folded structure is a tertiary structure.

12. The method of claim 11, wherein homology based information is used for the generation of forces for tertiary structure determination.

13. A method for sorting amino acid sequences, comprising:
providing a nucleic acid sequence;
determining amino acid sequences that may be potentially encoded by the nucleic acid sequence;
using the method of claim 1 to determine the folded structure of each of the amino acid sequences;
sorting the amino acid sequences according to the type, order or number of their predicted folded structures.

14. A method for ranking an array of amino acid sequence, comprising:
providing a nucleic acid sequence;
determining amino acid sequences that may be potentially encoded by the nucleic acid;
using the method according to claim 1 to determine the secondary structure of each of the amino acid sequences;
ranking the amino acid sequences according to the amount of the secondary structures produced by each amino acid sequence.

15. The method of claim 13, wherein the sorting of the amino acid sequences is aided by homology based information.

16. The method of claim 15, wherein the homology based information is derived from a nucleic acid sequence which is homologous to the nucleic acid and known to encode a particular amino acid sequence.

17. The method of claim 15, wherein the homology based information is derived from an amino acid sequence which is homologous to one or more amino acid sequences that are potentially encoded to the nucleic acid.

18. A method for determining the amino acid sequence of a protein or polypeptide with a pre-determined secondary structure, comprising
providing the pre-determined secondary structure;
generating all plausible amino acid sequences according to the given secondary structure;
using the method of claim 1 to predict the secondary structures of each of the generated amino acid sequences;
comparing each of the predicted secondary structures with the given secondary structure;
selecting the amino acid sequence having the predicted secondary structure that most closely fits with the pre-determined secondary structure provided.

19. The method of claim 18, wherein the plausible amino acid sequences are generated using either statistical, evolutionary or experimental input or a combination thereof.

20. A method for determining the presence or absence of a gene in a nucleic acid sequence, the method comprising:
providing a nucleic acid sequence and a corresponding amino acid sequence, wherein the amino acid sequence is a translation of the nucleic acid sequence;
applying a method of predicting protein structure to the amino acid sequence to determine the presence or absence of a folded region in the amino acid sequence;
determining the presence or absence of a gene in the nucleic acid sequence based on the presence or absence of a folded region in the amino acid sequence.

21. The method of claim 20 wherein the folded region is a secondary structure selected from the group consisting of an alpha helix and a beta sheet.

22. The method of claim 20 wherein the method of predicting protein structure is the method of claim 1.

23. The method of claim 20 wherein the method of predicting protein structure is the FK method.

24. The method of claim 20, wherein the nucleic acid is selected from the group consisting of DNA, RNA and cDNA.

25. The method of claim 20 further comprising using information gained from sequence homology.

26. The method of claim 21 further comprising using information from the primary nucleic acid sequence, the information comprising start and stop codons, splice sites, promoters, regulatory elements, and structural elements.

27. The method of claim 25 wherein the sequence homology is based on a nucleic acid sequence alignment.

28. The method of claim 25 wherein the sequence homology is based on an amino acid sequence alignment.

29. A method for determining the presence or absence of a structural mutation in an amino acid sequence, the method comprising:
providing a first amino acid sequence and a second amino acid sequence, wherein the second amino acid sequence is a natural variation of the first amino acid sequence;
applying a method of predicting protein structure to the first and the second amino acid sequences to determine the presence or absence of a folded region in the first and the second amino acid sequences;
comparing the presence or absence of the folded region in the first and the second amino acid sequence so as to correlate the presence or absence of a structural mutation due to the natural variation.

30. The method of claim 29 wherein the method of predicting protein structure is the FK method.

31. The method of claim 29 wherein the method of predicting protein structure is the method of claim 1.

32. The method of claim 29 wherein the natural variation is a mutation selected from the group comprising a point mutation, a deletion mutation, an insertion mutation, an inversion mutation, and an alternate splice.

33. The method of claim 29 wherein the folded region is a secondary structure selected from the group consisting of an alpha helix and a beta sheet.

34. The method of claim 29 wherein the first amino acid sequence is a naturally occurring protein.

35. A method for selecting the design of a protein, comprising:
(a) providing a first set of one or more amino acid sequences;
(b) applying a method of predicting protein structure to the first set of one or more amino acid sequences to determine the presence or absence of a folded region in each of the first set of one or more amino acid sequences;
(c) generating a second set of one of more amino acid sequences based on the predicted structure of the first set of one or more amino acid sequences;
(d) selecting one or more amino acid sequences based on the type, order and/or number of secondary structures produced by the first and the second set of one or more amino acid sequences to design a protein.

36. The method of claim 35 wherein the folded region is a secondary structure selected from the group consisting of an alpha helix and a beta sheet.

37. The method of claim 35 wherein the method of predicting protein structure is the FK method.

38. The method of claim 35 wherein the method of predicting protein structure is the method of claim 1.

39. The method of claim 35 wherein the artificial variation is a mutation selected from the group comprising a point mutation, a deletion mutation, an insertion mutation, an inversion mutation, and an alternate splice.

40. The method of claim 35 wherein the second set of one or more amino acid sequences is generated by a random mutation of the first set of one or more amino acid sequences.

41. The method of claim 35 wherein the second set of one or more amino acid sequences is generated by a directed mutation of the first set of one or more amino acid sequences.

42. The method of claim 35 wherein the generation of the second set of one or more amino acid sequences and the selecting of the amino acid sequences are according to a genetic algorithm.

43. The method of claim 35 further comprising reverse translating the designed protein into a nucleic acid sequence.

44. The method of claim 43 wherein the nucleic acid sequence is a DNA or RNA.

45. The method of claim 44 further comprising using the DNA or RNA to construct an artificial genome.
